(19) United States
(12) Patent Application Publication
(10) Pub. No.: US 2014/0358610 A1
(43) Pub. Date: Dec. 4, 2014

(54) DISCOVERING TASK DEPENDENCIES FOR INCIDENT MANAGEMENT

(71) Applicant: International Business Machines Corporation, Armonk, NY (US)

(72) Inventors: Marcos Dias de Assuncao, Rio de Janeiro (BR); Silvia Cristina Sardela Bianchi, Sao Paulo (BR); Marco Aurelio Stelmar Netto, Sao Paulo (BR)

(73) Assignee: International Business Machines Corporation, Armonk, NY (US)

(21) Appl. No.: 13/969,964

(22) Filed: Aug. 19, 2013

Related U.S. Application Data
(63) Continuation of application No. 13/909,751, filed on Jun. 4, 2013.

(51) Int. Cl. G06Q 10/06

(52) U.S. Cl. CPC G06Q 10/063114
USPC 705/7.15

(57) ABSTRACT

Resolving incidents occurring in managed infrastructure includes generating a first ticket indicating an occurrence of a first incident in the managed infrastructure, wherein the first ticket has been assigned to an analyst for resolution, generating a second ticket indicating an occurrence of a second incident in the managed infrastructure, wherein the second ticket has been assigned to an analyst for resolution, obtaining a component dependency graph that infers dependencies between a plurality of components of the managed infrastructure, and inferring a dependency graph from the component dependency graph, wherein the ticket dependency graph indicates a dependency between the first ticket and the second ticket.

### CROSS REFERENCE TO RELATED APPLICATIONS

This application is a continuation of U.S. patent application Ser. No. 13/909,751, filed Jun. 4, 2013, which is herein incorporated by reference in its entirety.

### FIELD OF THE DISCLOSURE

The present disclosure relates generally to incident management and relates more specifically to identifying dependencies among detected incidents.

### BACKGROUND OF THE DISCLOSURE

Incident management is a key service that ensures the proper operation of an information technology (IT) infrastructure in large organizations and data centers. In order to provide an agreed upon quality of service (e.g., as established in a service level agreement), a service provider needs to be able to identify and respond to incidents in a timely manner.

Typical incident management processes rely on systems that monitor the underlying services and infrastructure and identify potential issues that can impact the operation of a customer's business. A potential issue is generally reported in a semi-structured document (e.g., a “ticket”) containing details about the affected hardware components or services and a textual description explaining the issue. Incident management systems and personnel use the information in a ticket to determine who the best analyst to resolve the issue is.

Even though the process of monitoring the infrastructure and creating tickets is typically automated, a failure in infrastructure can result in the creation of multiple tickets that must be handled by different analysts or teams. Although the multiple tickets, or tasks, have dependencies, the details of these dependencies are not known a priori (i.e., before the tickets are assigned to individual analysts or teams).

### SUMMARY OF THE DISCLOSURE

In one embodiment, a tangible computer readable storage medium stores instructions which, when executed by a processor, cause the processor to perform operations for resolving incidents occurring in managed infrastructure, the operations including generating a first ticket indicating an occurrence of a first incident in the managed infrastructure, wherein the first ticket has been assigned to an analyst for resolution, generating a second ticket indicating an occurrence of a second incident in the managed infrastructure, wherein the second ticket has been assigned to an analyst for resolution, obtaining a component dependency graph that infers dependencies between a plurality of components of the managed infrastructure, and inferring a dependency graph from the component dependency graph, wherein the ticket dependency graph indicates a dependency between the first ticket and the second ticket.

In another embodiment, a system for resolving incidents occurring in managed infrastructure includes an incident management system for generating a first ticket indicating an occurrence of a first incident in the managed infrastructure, wherein the first ticket has been assigned to an analyst for resolution, and for generating a second ticket indicating an occurrence of a second incident in the managed infrastructure, wherein the second ticket has been assigned to an analyst for resolution, and a dependency discovery engine for obtaining a component dependency graph that infers dependencies between a plurality of components of the managed infrastructure and for inferring a ticket dependency graph from the component dependency graph, wherein the ticket dependency graph indicates a dependency between the first ticket and the second ticket.

### BRIEF DESCRIPTION OF THE DRAWINGS

The teachings of the present disclosure can be readily understood by considering the following detailed description in conjunction with the accompanying drawings, in which:

FIG. 1 is a block diagram depicting one example of a system for discovering task-dependency graphs, according to the present invention;

FIG. 2 illustrates an exemplary component dependency graph that illustrates the inferred dependencies between a plurality of components, along with the confidences in the inferred dependencies;

FIG. 3 is a flow diagram illustrating one embodiment of a method for discovering task dependencies for incident management, according to the present invention; and

FIG. 4 is a high level block diagram of the present invention implemented using a general purpose computing device.

To facilitate understanding, identical reference numerals have been used, where possible, to designate identical elements that are common to the Figures.

### DETAILED DESCRIPTION

In one embodiment, the present invention is a method and apparatus for discovering task dependencies for incident management. Embodiments of the invention automatically discover the dependency graph of a set of incident management tickets assigned to a group of analysts or system administrators (i.e., a “ticket dependency graph” or “ticket graph”). Knowing that a task being performed depends on the results of another task, or impacts the execution of other tasks, will allow analysts to better prioritize their activities and hence become work more productively. Further embodiments of the invention account for the current state of a system (e.g., individuals' activities and dependencies) so that analysts may resolve incidents more efficiently. These features allow service level agreements (or other metrics of service quality, efficiency, or effectiveness) to be met to a customer's satisfaction.

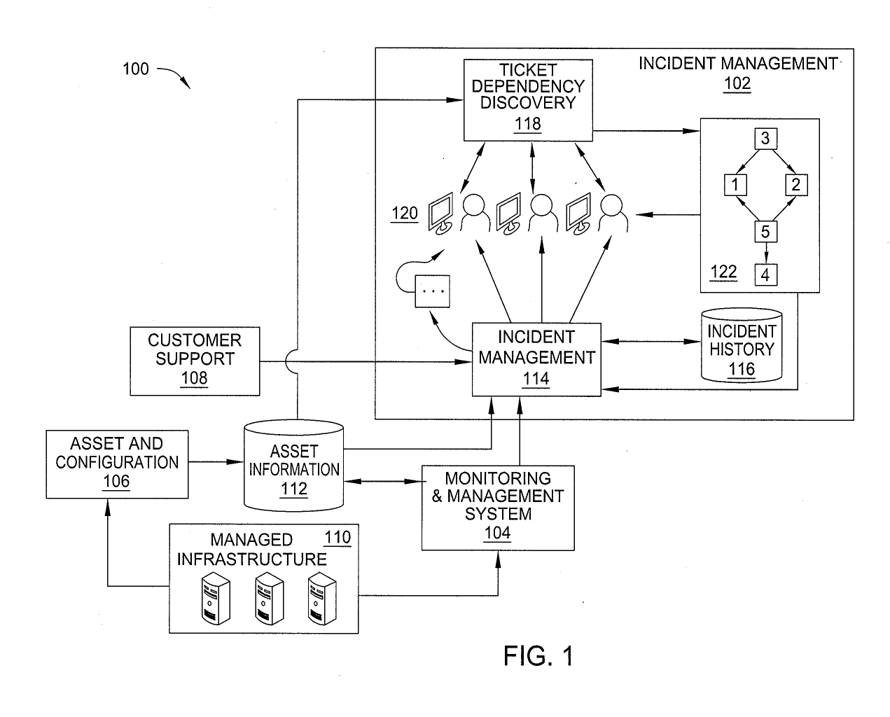

FIG. 1 is a block diagram depicting one example of a system for discovering task dependencies, according to the present invention. As illustrated, the system 100 generally comprises an incident management system 102, an infrastructure monitoring and management system 104, an asset and configuration system 106, and customer support system 108. The illustrated items are in addition to any other typical components that an organization might deploy to manage infrastructure and incidents.

The infrastructure monitoring and management system 104 is responsible for monitoring a managed infrastructure 110, such as an information technology (IT) infrastructure). To this end, the infrastructure monitoring and management system 104 identifies potential failures of the managed infrastructure 110 and creates tickets in response to these potential failures for resolution by the incident management system 102.

The asset and configuration system 106 discovers, stores, and manages information about the equipment, software, and systems that comprise the managed infrastructure 110, as well as the configurations of the equipment, software, and systems. The asset and configuration system 106 may also store the configuration map of the servers and application components, including their interdependence graphs (e.g., component graphs). This information is stored in an asset information repository or database 112 for use by other components of the system 100. The stored information may be discovered automatically by the asset and configuration system 106 or entered manually by the personnel responsible for asset configuration management. In a further embodiment, the operational statuses of the assets about which data is stored in the asset information database 112 may be updated by the infrastructure monitoring and management system 104.

The customer support system 108 is used by customers to report problems experienced with the services hosted by the service provider. Similar to the infrastructure monitoring and management system 104, problems reported to the customer support system 108 may result in the creation of tickets that are forwarded to the incident management system 102.

The incident management system 102 is responsible for receiving, scheduling, and assigning tickets so that problems detected by the infrastructure monitoring and management system 104 or reported via the customer support system 108 can be resolved by system administrators. To this end, the incident management system 102 comprises an incident management engine 114, an incident history repository or database 116, and a ticket dependency discovery engine 118.

The incident management engine 114 receives, schedules, and assigns the tickets, as discussed above, possibly utilizing incident history data stored in the incident history database 116 to facilitate these operations. In particular, the incident management engine 114 assigns tickets to specific human analysts 120 for resolution. In one embodiment, the assignment of a ticket is based on a variety of factors (e.g., the expected complexity of the problem, the skills of the available analysts 120, the resolution deadlines, etc.). Once a ticket is assigned to an analyst 120, she may choose to share information about her current tasks with the ticket dependency discovery engine 118 (e.g., for the purposes of determining whether any other analysts have been assigned tickets whose related tasks may depend on her tasks).

The incident history database 116 stores all tickets that are created as a result of problems detected by the infrastructure monitoring and management system 104 or reported via the customer support system 108. As discussed above, this data may help to resolve future tickets and is thus stored for data mining purposes.

The ticket dependency discovery engine 118 infers a ticket dependency graph 122 from messages exchanged by the analysts 120, information contained in the tickets, and the asset configuration data. Thus, the ticket dependency discovery engine 118 cross references information from various sources in order to identify whether there are dependencies in the tickets assigned to different analysts 120. If a ticket dependency graph 122 is discovered, the ticket dependency discovery engine 118 may provide the ticket dependency graph 122 to other components of the system 100, such as the incident management engine 114 and/or the analysts 120.

Armed with the ticket dependency graph 122, analysts 120 can coordinate their tasks and prioritize activities that impact other tasks, thus reducing overall incident resolution time. The incident management engine 114 can use the ticket dependency graph 122 to improve the scheduling and rescheduling of tickets.

Embodiments of the invention assume the existence of a component dependency graph, where a component may be, for example, a piece of software, a piece of hardware, or a subsystem. The component dependency graph may be created and/or refined by a system administrator (e.g., based on experience) or automatically (e.g., by analyzing ticket information). Component dependency graphs may also be instantiated or configured per-customer, per-location, or per-system subset.

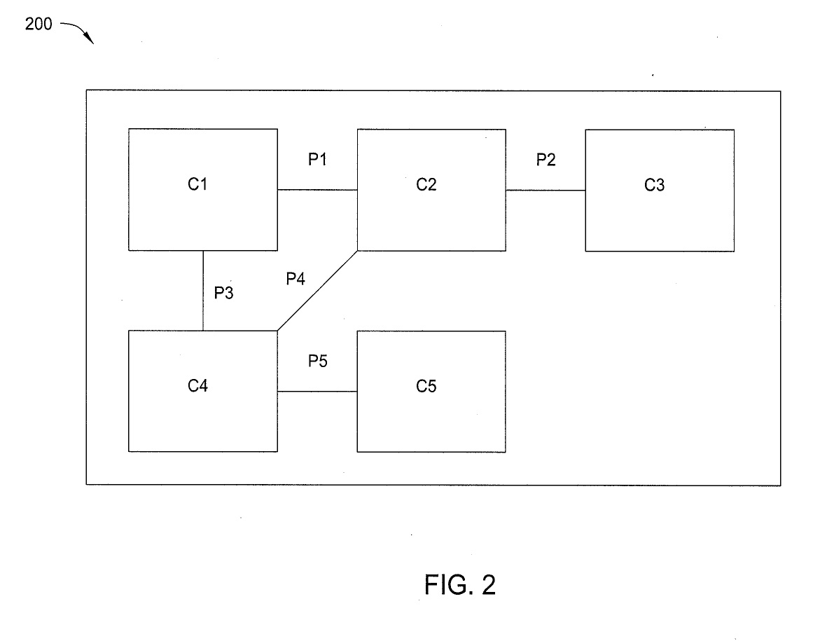

FIG. 2, for instance, illustrates an exemplary component dependency graph 200 that illustrates the inferred dependencies between a plurality of components (C1-C5), along with the confidences in the inferred dependencies (indicated by the probabilities P1-P5 assigned to the edges of the graph). A component dependency graph such as the one illustrated in FIG. 2 may be used to generate a ticket dependency graph that assists in discovering task dependencies.

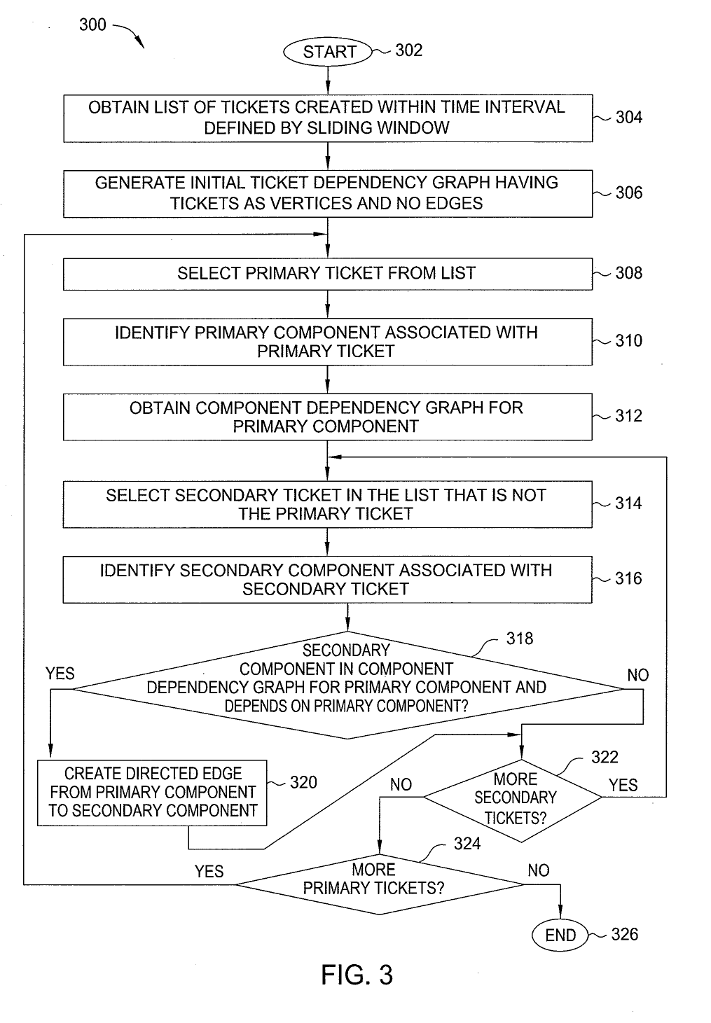

FIG. 3, for example, is a flow diagram illustrating one embodiment of a method 300 for discovering task dependencies for incident management, according to the present invention. The method 200 may be implemented, for example, by the system 100 illustrated in FIG. 1. As such, reference is made in the discussion of the method 300 to various components of the system 100 illustrated in FIG. 1. Such reference is made for illustrative purposes only and does not limit the method 300 to implementation by the system 100.

The method 300 uses a sliding window of length w and attempts to find dependencies among a group of tickets that have been created within a given time interval. The length w of the sliding window is configurable (e.g., for the sake of illustration, it may be considered to be one hour). In addition, when attempting to discover dependencies, the method 300 accounts for service-to-equipment dependencies, service-to-service dependencies, and past ticket information. Also, as discussed above, the method 300 assumes the existence of at least one component dependency graph.

The method 300 begins in step 302. In step 304 the ticket dependency discovery engine 118 obtains the list T of tickets created within a time interval defined by the sliding window w.

In step 306, the ticket dependency discovery engine 118 generates an initial ticket dependency graph D having the tickets t in the list T as vertices, and having no edges.

In step 308, the ticket dependency discovery engine 118 selects a ticket t from the list T of tickets. The ticket t selected in step 308 is referred to hereinafter as the “primary ticket.”

In step 310, the ticket dependency discovery engine 118 identifies a service or hardware component c associated with the primary ticket (e.g., a database, a web application, a server, backup storage, or the like). The service or hardware component c identified in step 310 is referred to hereinafter as the “primary component.”

In step 312, the ticket dependency discovery engine 118 obtains a component dependency graph Sc for the primary component c. As discussed above, the method 300 assumes the existence of such a component dependency graph.

In step 314, the ticket dependency discovery engine 118 selects a ticket tc in the list T that is not the primary ticket t. The ticket tc selected in step 314 is referred to hereinafter as the “secondary ticket.”

In step 316, the ticket dependency discovery engine 118 identifies a service or hardware component cc associated with the secondary ticket tc. The service or hardware component c identified in step 316 is referred to hereinafter as the “secondary component.”

In step 318, the ticket dependency discovery engine 118 determines whether the secondary component cc is in the component dependency graph Sc and whether the secondary component cc depends on the primary component c according to the component dependency graph Sc.

If the ticket dependency discovery engine 118 concludes in step 318 that the secondary component cc is in the component dependency graph Sc for the primary component c and that the secondary component cc depends on the primary component c according to the component dependency graph Sc, then the method 300 proceeds to step 320. In step 320, the ticket dependency discovery engine 118 creates a directed edge connecting the primary component c and the secondary component cc with a minimum weight. The method 300 then proceeds to step 322, described below.

If the ticket dependency discovery engine 118 concludes in step 318 that the secondary component cc is not in the component dependency graph Sc for the primary component c and/or that the secondary component cc does not depend on the primary component c according to the component dependency graph Sc, then the method 300 proceeds to step 322. In step 322, the ticket dependency discovery engine 118 determines whether there are any secondary tickets tc remaining in the list T of tickets.

If the ticket dependency discovery engine 118 concludes in step 322 that there is another secondary ticket tc remaining in the list T of tickets, then the method 300 returns to step 314 and selects a next secondary ticket tc for analysis according to steps 316-320.

Alternatively, if the ticket dependency discovery engine 118 concludes in step 322 that there are no more secondary tickets tc remaining in the list T of tickets, then the method 300 proceeds to step 324. In step 324, the ticket dependency discovery engine 118 determines whether there are any more primary tickets t in the list T of tickets.

If the ticket dependency discovery engine 118 concludes in step 324 that there is another primary ticket t remaining in the list T of tickets, then the method 300 returns to step 308 and selects a next primary ticket t for analysis according to steps 308-320.

Alternatively, if the ticket dependency discovery engine 118 concludes in step 322 that there are no more primary tickets t remaining in the list T of tickets, then the method 300 ends in step 326.

The result of the method 300 is a ticket dependency graph D. Degrees of confidence in the inferred dependencies illustrated in the ticket dependency graph D can be indicated visually using varying colors or line weights for the edges that indicate dependencies.

Once this initial ticket dependency graph D is inferred, historical data about past tickets and feedback from analysts can be used to refine the initial weights (and the confidences in the weights) assigned to the edges in ticket the dependency graph D. A similarity function can be used to find tickets that are similar to the tickets t created during the analyzed window w of time and also to find dependencies among past tickets.

Once the ticket dependency graph D has been refined automatically using historical information, analysts who are working on resolving the tickets t in the ticket dependency graph D can be notified of the tasks that are believed to depend on the tasks relating to their tickets. In one embodiment, the analysts are asked to confirm these believed dependencies, which can help to further refine the ticket dependency graph D. For instance, weights assigned to edges that have not been deleted due to an analyst denying a dependency may be increased or decreased accordingly.

Embodiments of the invention thus automatically discover the dependency graph of a set of incident management tickets assigned to a group of analysts or system administrators. Knowing that a task being performed depends on the results of another task, or impacts the execution of other tasks, will allow analysts to better prioritize their activities and hence become work more productively.

As an example, suppose that several tickets associated with a particular server have been generated. A first of these tickets, which indicates that an application is not responding, is assigned to the system administrator, Alice, who is acting on work group “middleware.” A second of the tickets, which indicates that the server is disconnected, is assigned to the system administrator, Bob, who is acting on the work group “network.” If Alice knows that Bob is fixing the network connection for the server, she can prioritize other tasks, since the problem indicated by the second ticket is the most likely cause of the problem indicated by the first ticket.

As a different example, suppose that two tickets are created for the same server. The first ticket indicates a backup failure, and the second ticket indicates that only two percent of the memory is available. If a ticket dependency graph infers a dependency between these two tickets, then the system administrators may be able to prioritize their tasks and solve both problems more quickly.

In some embodiments, master ticket dependency graphs may be created for specific customers, locations, or system subsets. Furthermore, embodiments of the invention aggregate information about clients and accounts from external subsystems (e.g., forums, alerts, calendar information, instant messages) to improve awareness.

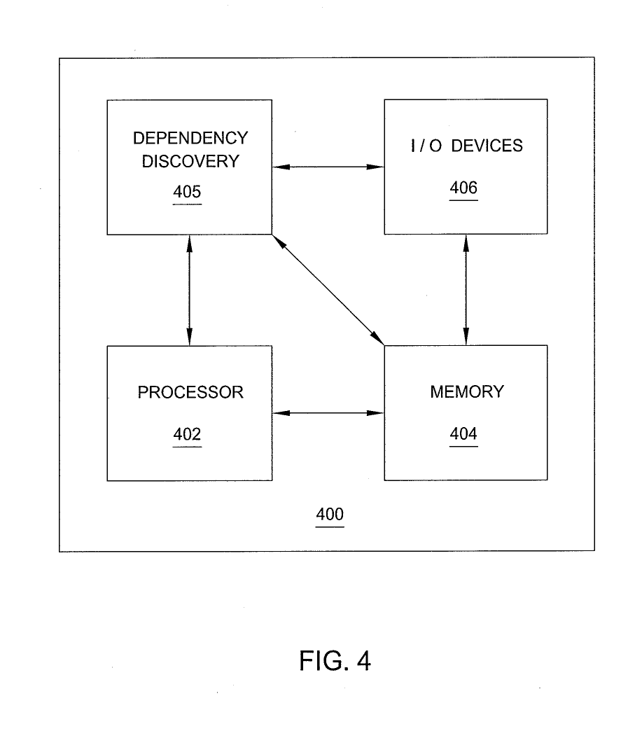

FIG. 4 is a high level block diagram of the present invention implemented using a general purpose computing device 400. In one embodiment, the general purpose computing device 400 is deployed as a ticket dependency discovery engine, such as the ticket dependency discovery engine 118 illustrated in FIG. 1. It should be understood that embodiments of the invention can be implemented as a physical device or subsystem that is coupled to a processor through a communication channel. Therefore, in one embodiment, a general purpose computing device 400 comprises a processor 402, a memory 404, a dependency discovery module 405, and various input/output (I/O) devices 406 such as a display, a keyboard, a mouse, a modem, a microphone, speakers, a touch screen, an adaptable I/O device, and the like. In one embodiment, at least one I/O device is a storage device (e.g., a disk drive, an optical disk drive, a floppy disk drive).

Alternatively, embodiments of the present invention (e.g., dependency discovery module 405) can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the dependency discovery module 405 for discovering task-dependency graphs for incident management described herein with reference to the preceding Figures can be stored on a tangible or non-transitory computer readable medium (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

Although various embodiments which incorporate the teachings of the present invention have been shown and described in detail herein, those skilled in the art can readily devise many other varied embodiments that still incorporate these teachings.

What is claimed is:

1. A tangible computer readable storage medium that stores instructions which, when executed by a processor, cause the processor to perform operations for resolving incidents occurring in managed infrastructure, the operations comprising:
generating a first ticket indicating an occurrence of a first incident in the managed infrastructure, wherein the first ticket has been assigned to an analyst for resolution;
generating a second ticket indicating an occurrence of a second incident in the managed infrastructure, wherein the second ticket has been assigned to an analyst for resolution;
obtaining a component dependency graph that infers dependencies between a plurality of components of the managed infrastructure; and
inferring a ticket dependency graph from the component dependency graph, wherein the ticket dependency graph indicates a dependency between the first ticket and the second ticket.

2. The tangible computer readable storage medium of claim 1, wherein at least one of the first incident and the second incident is automatically detected by an incident management system.

3. The tangible computer readable storage medium of claim 1, wherein at least one of the first incident and the second incident is reported by a customer of the managed infrastructure.

4. The tangible computer readable storage medium of claim 1, wherein the managed infrastructure is an information technology infrastructure.

5. The tangible computer readable storage medium of claim 1, wherein the dependency indicates that resolution of the first incident depends on resolution of the second incident.

6. The tangible computer readable storage medium of claim 1, wherein the dependency indicates that resolution of the first incident is impacted by resolution of the second incident.

7. The tangible computer readable storage medium of claim 1, wherein the first ticket and the second ticket are both generated within a period of time defined by a sliding window.

8. The tangible computer readable storage medium of claim 1, wherein the first ticket and the second ticket comprise vertices of the ticket dependency graph.

9. The tangible computer readable storage medium of claim 1, wherein the inferring comprises:
identifying a first component of plurality of components that is associated with the first ticket;
identifying a second component of the plurality of components that is associated with the second ticket; and
creating a directed edge in the component dependency graph that connects the first component and the second component.

10. The tangible computer readable storage medium of claim 9, wherein the creating is performed only when the second component is in the component dependency graph and when the component dependency graph for indicates that the second component depends on the first component.

11. The tangible computer readable storage medium of claim 9, wherein the directed edge is assigned a minimum weight.

12. The tangible computer readable storage medium of claim 9, wherein at least one of the first component or the second component is a service.

13. The tangible computer readable storage medium of claim 9, wherein at least one of the first component or the second component is hardware.

14. The tangible computer readable storage medium of claim 9, wherein the operations further comprise:
refining the ticket dependency graph.

15. The tangible computer readable storage medium of claim 14, wherein the refining is performed automatically using historical data.

16. The tangible computer readable storage medium of claim 15, wherein the historical data comprises data about tickets that have been generated in the past for the managed infrastructure.

17. The tangible computer readable storage medium of claim 14, wherein the refining is performed using feedback from a human analyst.

18. The tangible computer readable storage medium of claim 17, wherein the feedback confirms or denies the existence of a dependency indicated in the ticket dependency graph.

19. A system for resolving incidents occurring in managed infrastructure, comprising:
an incident management system for generating a first ticket indicating an occurrence of a first incident in the managed infrastructure, wherein the first ticket has been assigned to an analyst for resolution, and for generating a second ticket indicating an occurrence of a second incident in the managed infrastructure, wherein the second ticket has been assigned to an analyst for resolution; and
a dependency discovery engine for obtaining a component dependency graph that infers dependencies between a plurality of components of the managed infrastructure and for inferring a ticket dependency graph from the component dependency graph, wherein the ticket dependency graph indicates a dependency between the first ticket and the second ticket.
